(19) United States
(12) Patent Application Publication
(10) Pub. No.: US 2014/0106771 A1
(43) Pub. Date: Apr. 17, 2014

(54) AVOIDING DISTURBANCE OF RESTRICTED LOCAL ACCESS POINTS IN A WIRELESS NETWORK

(71) Applicant: TELEFONAKTIEBOLAGET L M ERICSSON (PULB), Stockholm (SE)

(72) Inventors: Anders Larsson, Kuala Lampur (MY); Thomas Walldeen, Linkoping (SE); Martin Bäckström, Cyberjaya (MY)

(73) Assignee: TELEFONAKTIEBOLAGET L M ERICSSON (PULB), Stockholm (SE)

(21) Appl. No.: 14/134,697

(22) Filed: Dec. 19, 2013

Related U.S. Application Data
(63) Continuation of application No. 12/280,275, filed on Aug. 21, 2008.
(60) Provisional application No. 60/774,663, filed on Feb. 21, 2006.

(51) Int. Cl. H04W 52/32

(52) U.S. Cl. CPC H04W 52/322
USPC 455/452.1; 455/561

(57) ABSTRACT

The invention concerns a method of determining output power in a first restricted local access point in a wireless network, a device implementing a restricted local access point, a wireless network as well as a computer program product for determining output power in a restricted local access point. A restricted local access point scans the network for determining broadcasting channels (B₁, B₂, B₃, B₅, B₆) used by surrounding access points, selects a broadcasting channel (B₄, f₂) that receives the lowest disturbance by surrounding access points, varies the output power of this channel for obtaining a desired relation to the disturbance and determines if a main disturbing access point is another restricted local access point. If it is, a threshold is set for one of the quantities of the relation, which the quantity is not allowed to pass, the output power is varied for providing the desired relation without said quantity passing said threshold and otherwise another channel is selected.

### CLAIMING BENEFIT OF PRIOR FILED APPLICATIONS

This application is a continuation of U.S. application Ser. No. 12/280,275, filed Aug. 21, 2008, now pending, which is a 371 of International Application No. PCT/SE2006/050164, filed May 30, 2006 which claims the benefit of U.S. Application No. 60/774,663 filed Feb. 21, 2006. The contents of these disclosures are hereby incorporated herein by reference.

### TECHNICAL FIELD OF THE INVENTION

The present invention relates to the field of telecommunication. The invention more particularly relates to a method of determining output power for communication with mobile stations in a first restricted local access point in a wireless network, a device implementing a restricted local access point for provision in such a wireless network, such a wireless network as well as a computer program product for determining output power for communication with mobile stations in a restricted local access point in a wireless network.

### DESCRIPTION OF RELATED ART

There has for some time been of interest to allow the use of one and the same mobile station at home and in a public wireless network.

For this reason there has been provided stations that have a dual mode operation, one cellular mode and one cordless mode. The mobile station then switches between modes as it moves between a public cellular network and a cordless base station. This is advantageous if a mobile station is to be provided in two different networks.

However these stations require exchange of the existing legacy cellular phone owned by the end user and are furthermore costly for the end user because of the dual mode operation.

It would therefore be of interest to allow a mobile station to be used both at home and in a cellular network and without the user having to acquire a special dual mode mobile station, i.e. through the user using an ordinary mobile station adapted for use in the public cellular network and to use it in his home with a home base station. This also opens the market of public wireless network operators to the home telephony segment. This also means that this home base station functionality has to be provided by a special access point, in the form of a restricted local access point, in the wireless network.

The ordinary access points of as network are also called unrestricted global access points and are provided with broadcasting channels, normally implemented using a certain frequency, where the channels have been selected before the access points have been placed out, in order for the broadcasting channels to interfere as little as possible with each other. This is part of what is called cell planning. In cell planning there is a desire to use as few unrestricted global access points as possible using a fixed set of frequencies or channels while at the same time trying to limit the interference of different access points on each other to acceptable levels. This is a very complex task. A restricted local access point is however provided directly to an end-user or consumer. This means that it is impossible to know when and where in the network a restricted local access point will be provided. As a consequence cell planning that considers also restricted local access points is very hard, not to say impossible, to perform. When providing such a restricted local access point within a wireless network, disturbances, for instance in the form of interference, may be provided by a restricted local access point on surrounding access points and naturally surrounding access points may also disturb the restricted local access point. If one other surrounding access point is also a restricted local access point, these may thus provide disturbances of each other.

The present invention is therefore directed towards limiting the disturbances provided by restricted local access points of each other.

### SUMMARY OF THE INVENTION

One object of the present invention is thus directed towards providing a method of determining output power for communication with mobile stations in a first restricted local access point in a wireless network that limits the disturbances provided by restricted local access points of each other.

This object is according to a first aspect of the present invention achieved through a method of determining output power for communication with mobile stations in a first restricted local access point in a wireless network, comprising the steps of:
scanning the network for determining broadcasting channels used by surrounding wireless access points,
selecting a broadcasting channel that receives the lowest disturbance from surrounding access points,
varying the output power of the selected broadcasting channel in order to provide a desired relation to the disturbance,
determining if a main disturbing access point is another restricted local access point, and
in case it is, performing the further steps of
   setting a threshold for one of the quantities of the relation, which the quantity in question is not allowed to pass,
   varying the output power for providing the desired relation without said quantity passing said threshold, and
   selecting another channel if the desired relation cannot be obtained without the quantity passing the threshold.

Another object of the present invention is directed towards providing a device implementing a restricted local access point for provision in a wireless network that limits the disturbances provided by restricted local access points of each other.

This object is according to a second aspect of the present invention achieved through a device implementing a restricted local access point for provision in a wireless network and being arranged to
scan the network for determining broadcasting channels used by surrounding wireless access points in the network,
select a broadcasting channel that receives the lowest disturbance by surrounding access points,
vary the output power of the selected broadcasting channel in order to provide a desired relation to the disturbance,
determine if a main disturbing access point is another restricted local access point, and
in case it is,
   set a threshold for one of the quantities of the relation, which the quantity in question is not allowed to pass,
   vary the output power for providing the desired relation without said quantity passing said threshold, and
   select another channel if the desired relation cannot be obtained without the quantity passing the threshold.

Another object of the present invention is directed towards providing a wireless network that limits the disturbances provided by restricted local access points of each other.

This object is according to a third aspect of the present invention also achieved through a wireless network comprising:
a number of unrestricted global access points, and
a number of devices, each implementing a restricted local access point,
where a device implementing a restricted local access point is arranged to scan the network for determining broadcasting channels used by surrounding wireless access points in the network,
   select a broadcasting channel that receives the lowest disturbance by surrounding access points,
   vary the output power of the selected broadcasting channel in order to provide a desired relation to the disturbance,
   determine if a main disturbing access point is another restricted local access point, and
   in case it is,
      set a threshold for one of the quantities of the relation, which the quantity in question is not allowed to pass,
      vary the output power for providing the desired relation without said quantity passing said threshold, and
      select another channel if the desired relation cannot be obtained without the quantity passing the threshold.

Still another object of the present invention is directed towards providing a computer program product that limits the disturbances provided by restricted local access points of each other.

This object is according to a fourth aspect of the present invention also achieved through a computer program product for determining output power for communication with mobile stations in a restricted local access point in a wireless network, comprising computer program code to make a device implementing such a restricted local access point perform, when the code is loaded into said device:
scan the network for determining broadcasting channels used by surrounding wireless access points in the network,
select a broadcasting channel that receives the lowest disturbance by surrounding access points,
vary the output power of the selected broadcasting channel in order to provide a desired relation to the disturbance,
determine if a main disturbing access point is another restricted local access point, and
in case it is,
   set a threshold for one of the quantities of the relation, which the quantity in question is not allowed to pass,
   vary the output power for providing the desired relation without said quantity passing said threshold, and
   select another channel if the desired relation cannot be obtained without the quantity passing the threshold.

An unrestricted global access point is here defined as an access point which when provided in a network allows all mobile stations in the network to essentially communicate on equal terms, while a restricted local access point is here defined as an access point that has a separate set of rules relating to a limited set of mobile stations within the network and is mainly intended to allow these stations to communicate with a specific restricted local access point. Alternatively a restricted local access point can be restricted only in the sense of having lower output power, thus creating a range of coverage restricted to its close vicinity.

The present invention has many advantages. It offers the best service quality for users of a restricted local access point while at the same time limiting a total system interference in a flexible way. There is furthermore ensured that repeated output power changes made by two or more restricted local access points are discontinued so that the system interference is limited. The invention thus maintains service quality, while avoiding unnecessary interference on surrounding access points.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The present invention will now be described in more detail in relation to the enclosed drawings, in which:

FIG. 1 schematically shows a wireless network comprising three unrestricted global access points and three restricted local access points, where each restricted local access point is being provided in a house, as well as a number of related entities of the network,

FIG. 2 shows a block schematic of different units of a restricted local access point,

FIG. 3 schematically outlines broadcasting channels of the access points in the network as well as network identities provided when broadcasting,

FIG. 4 shows a flow chart of a number of method steps performed in a restricted local access point according to the present invention, and

FIG. 5 shows a table indicating different numbering intervals that are used for network identities of ordinary access points and restricted local access points according to one variation of the present invention.

### DETAILED DESCRIPTION OF EMBODIMENTS

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

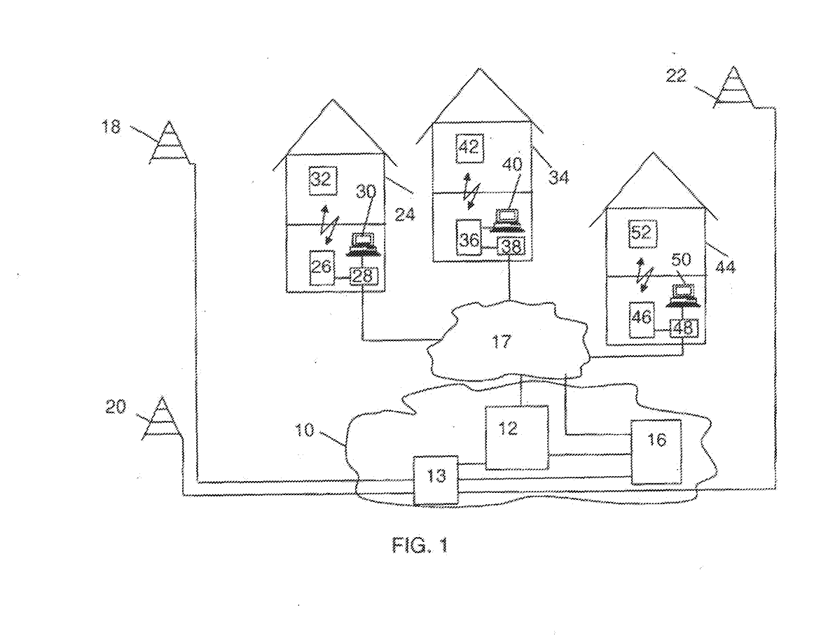

The present invention is described in the non-limiting, context of a wireless network in the form of a Public Land Mobile Network that is here a GSM (Global System for Mobile communications) network 10 shown in FIG. 1. Here it should be realised that the network is in no way limited to GSM, but can be any type of public land mobile network, like GPRS (General Packet Radio Service), UMTS (Universal Mobile Telecommunications System). It can also be based on for instance WLAN (Wireless Local Area Network) technology. The network 10 here includes at least one first traffic control unit 12, which in the case of GSM is an MSC (Mobile Services Switching Centre). If the network was a GPRS network this unit would be as SGSN (Serving GPRS Support Node) instead. The first traffic control unit 12 is furthermore connected to a first, second and third unrestricted global access point 18, 20 and 22 in the form of base stations via a second traffic control unit 13 in the form of a BSC (Base Station Controller). It is possible to combine GPRS and GSM networks. In this case the second traffic control unit 13 would be connected to both an MSC and a SGSN. The base stations 18, 20, 22 are ordinary base stations, which any mobile station being allowed to communicate in the network 10 can use for communication. The network 10 also includes an Operation and Maintenance service centre 16, where customer service is handled. This service centre 16 is also connected to both the traffic control units 12 and 13. It may also be connected to unrestricted global access points (not shown). The service centre 16 and the first traffic control unit 12 are furthermore both connected to an external communication network 17, which is here the Internet. It should be realised that the first traffic control unit 12 may be connected to several second traffic control units 13, and that there may be several more first traffic control units 12 in the wireless network 10 in order to control communication with mobile stations via one or more access points. It should also be realised that the network 10 need not be provided with a central traffic control unit at all. What has been described so far is well known within the art.

In FIG. 1 there are also shown three different buildings 24, 34 and 44, where a first building 24 includes a first restricted local access point 26 connected to a modem 28. The modem 28 is connected to the external network 17 as well as to a computer 30 also provided in the first building. There is also provided a first user mobile station 32 communicating with the first restricted local access point 26. The first user mobile station 32 is here associated with the first restricted local access point 26. The second building 34 includes a second restricted local access point 36 connected to a modem 38, which in turn is connected to the external network 17. Here a computer 40 is connected to the second restricted local access point 36 for connection to the modem 38. The reason for this is that this modem is of a type which only allows one other device to be connected to it. In this second building 34 there is a second user mobile station 42 that is associated with the second restricted local access point 36. Finally the third building 44 includes a third restricted local access point 46 connected to a modem 48. The modem 48 is connected to the external network 17, as well as to a computer 50 also provided in the third building 44. There is finally provided a third user mobile station 52 communicating with the third restricted local access point 46, where this third user mobile station 52 is a mobile station associated with the third restricted local access point 46.

It should here be realised that the restricted local access points 26, 36 and 46 for the first, second and third user mobile stations 32, 42, 52 act as access points within the network 10 and are controlled by the first traffic control unit 12. The external network 17 is in this case just a channel that is used for providing this communication and control between the network 10 and the restricted local access points. The external network 17 may also provide other types of communication with for instance the service centre 16. The reason for using the Internet is that many households have easy access to it. For this reason it is also evident that the external network can be any network that is provided for a household and can for instance be a cable TV network instead. In case the household has direct access to a LAN network, a modem might also not be needed. There are thus several ways in which this communication channel may be provided.

The purpose of providing a restricted local access point in this way, is to let the operator of the network 10 simulate a home base station within his own network, where an end user can use his ordinary mobile station also via this restricted access point. At the same time the user is automatically allowed to use the mobile station in the rest of the public wireless network 10 whenever there is no or insufficient contact with the restricted local access point. In this way it is for instance possible to delete a fixed land line network connection for an end user. The operator may then also provide different billing strategies for calls made via a restricted local access point and via unrestricted global access points in the network. For the user of the mobile station, the mobile station is thus to resemble a cordless phone when inside the building and an ordinary mobile station when being provided outside the building. There is furthermore no need for the end user to keep track of several different phone numbers. However the restricted local access point is controlled by the operator of the network. In order to provide economy, it is furthermore often desirable that such a restricted local access point be provided at a low cost. This also means that it normally is much smaller, weaker in transmission power and provided with fewer traffic channels as compared with an ordinary access point, which furthermore may cover the restricted local access point as an umbrella. Thus an ordinary access point may be much stronger than the restricted local access point in the area the restricted local access point is intended to cover.

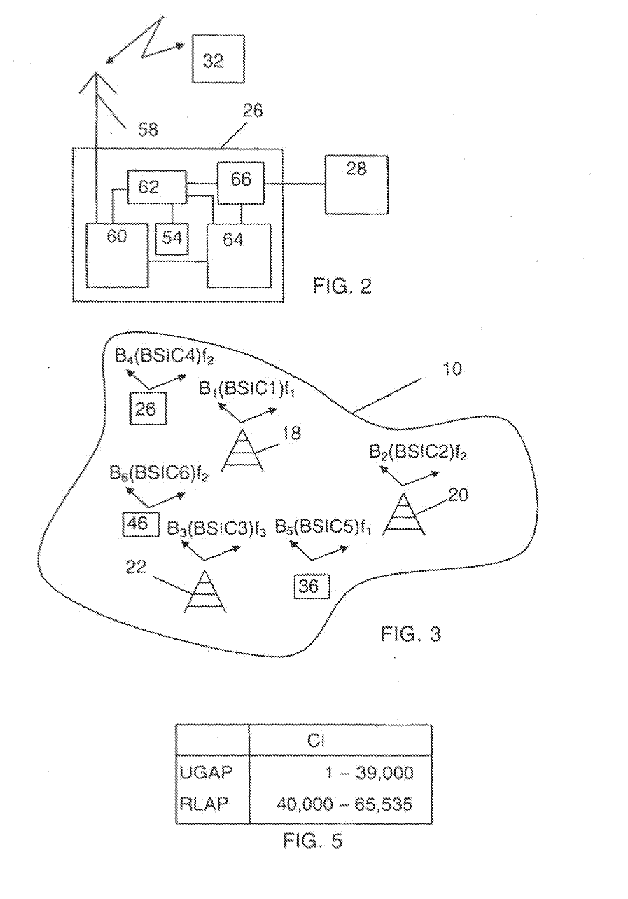

FIG. 2 shows a block schematic of some relevant units of a device implementing the first restricted local access point 26 and the different other devices it communicates with in the first building. It should be realised that the other restricted local access points may be provided in the same way. This device 26 comprises an antenna 58 communicating with the first user mobile station 32, which antenna 58 is connected to a radio circuit 60, which in turn may be provided in the form of an ordinary mobile station chipset that is made to operate in a special way. The radio circuit 60 is connected to a control unit 62 and to a signal conversion unit 64 converting circuit switched voice to packet based voice. The signal conversion unit 64 may use UMA/GAN (Unlicensed Mobile Access/Generic Access Network), which is a standard for making GSM calls over 802.11 or Bluetooth, where GSM protocols are tunneled over unlicensed bands. Both the control unit 62 and the signal conversion unit 64 are connected to an interface 66 that in turn is connected to the modem 28. The control unit 62 is furthermore connected to an access point identity store 54.

As mentioned above the restricted local access point is much weaker than other access points. It can make up for this by monitoring the surrounding access points and selecting a broadcasting channel that is disturbed the least. According to the invention, it can thereafter when broadcasting information make up for some of the interference through increasing the broadcasting power. This has limited effect on an unrestricted global access point in the network. However this may have a large effect on other restricted local access points in the vicinity of the restricted local access point in question. If two such restricted local access points therefore disturb each other and only respond by increasing their broadcasting power, the system interference is increased. Energy is furthermore unnecessarily wasted without providing any better performance.

The present invention is directed towards solving this problem.

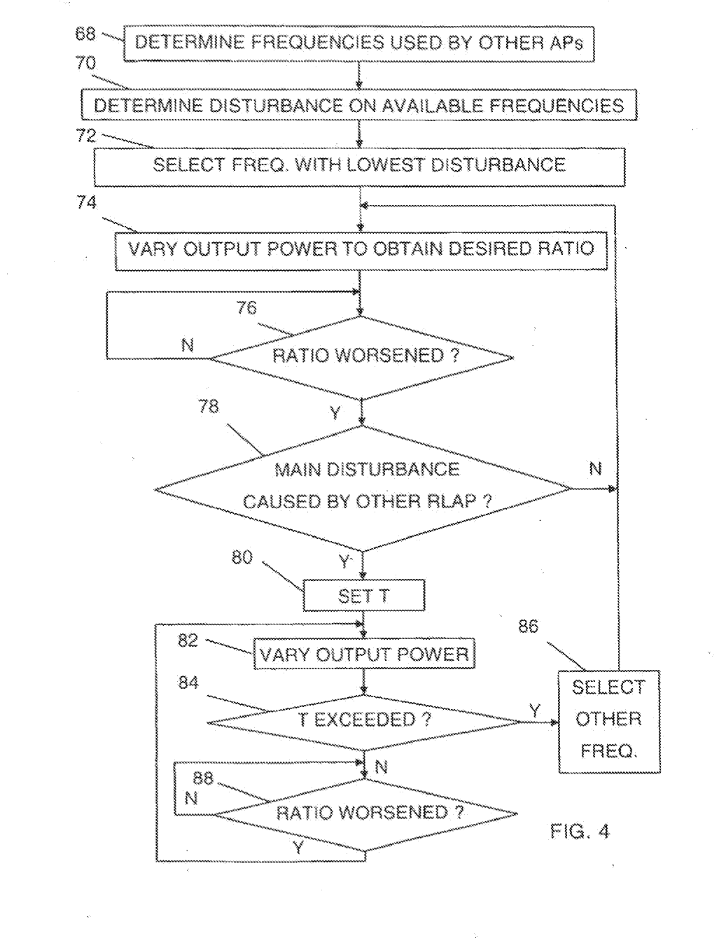

Now the principles of the present invention will be described with reference also being made to FIG. 3, which schematically outlines broadcasting channels of the different access points in the network as well as network identities provided when broadcasting and to FIG. 4, which shows a flow chart of a method according to the present invention performed by a restricted local access point.

As a restricted local access point, here with the first restricted local access point 26 taken as an example, is first put to use, the control unit 62 orders the radio communication unit 60 to scan the network 10 in order to determine the broadcasting channels of the surrounding wireless access points AP in the network and more particularly when GSM is concerned, the frequencies of these Access Points AP, step 68. When doing this it may then detect both unrestricted global and restricted local access points. Thus it may detect the first unrestricted global access point 18 that broadcasts information on a broadcasting channel B₁ including an access point identity BSIC1 (Base Station Identity Code) on a first frequency f₁, the second unrestricted global access point 20 that broadcasts information on a broadcasting channel B₂ including an access point identity BSIC2 on a second frequency f₂, the third unrestricted global access point 22 that broadcasts information on a broadcasting channel B₃ including an access point identity BSIC3 on a third frequency f₃, the second restricted local access point 36 that broadcasts information on a broadcasting channel B₅ including an access point identity BSIC5 also on the first frequency f₁ and the third restricted local access point 46 that broadcasts information on a broadcasting channel B₆ including an access point identity BSIC6 also on the second frequency f₂. When this has been done the results are provided from the radio communication unit 60 to the control unit 62, which stores or registers the detected identities BSIC together with the corresponding frequencies in the identity store 54. Then the control unit 62 determines the disturbances on the available frequencies, i.e. all the frequencies that it may use for broadcasting channels, step 70. It does this by ordering the radio communication unit 60 to perform interference measurements on the different frequencies used and relating the measured interference to a nominal output power value in order to obtain a C/I (signal over interference) ratio. Thereafter the control unit 62 selects the frequency that has the lowest disturbance, step 72, which is the frequency having the highest C/I ratio. When that has been done, the control unit 62 varies or sets the output power level that is to be used in order for the mobile station to experience a desired C/I value, step 74. Typically this can be a ratio of about +12 dB. Thereafter the radio communication unit 60 is ordered to broadcast on the selected frequency with the newly set power level. In the present example the first restricted local access point 26 has decided that the second frequency f₂ is the best and broadcasts information including its own access point identity BSIC4 on this frequency.

The first restricted local access point 26 then keeps using this power level while at the same time monitoring the C/I ratio of the selected frequency. If the ratio is then worsened, step 76, it goes on and investigates if the main cause of the disturbance that worsens the ratio is caused by another local restricted access point or by an ordinary unrestricted global access point, step 78. This may be done through looking at the registrations that have been made in the access point identity store 54. In case the disturbance was caused by an unrestricted global access point, the control unit 62 goes back an orders the radio communication unit 60 to vary the output power level in order to achieve the desired C/I ratio, step 74. Typically the output level is incremented in steps of about 2 dB. In case the disturbance was caused by another restricted local access point, step 78, the control unit 62 goes on and sets a threshold T, step 80, for the output power that it cannot exceed. The output power is again varied in order to achieve the desired ratio, step 82. The output power level is then compared with the threshold T, step 84, and in case the threshold was not exceeded, step 84, the first restricted local access point 26 keeps on broadcasting on the same frequency with the set power level as long as the ratio is not worsened, step 88, while if the ratio was worsened, step 88, the output power is again varied, step 82, and a check is again made if the threshold was exceeded, step 84. Any time that the threshold T is exceeded, the control unit 62 decides that the frequency is not a suitable frequency. In the present example also the third restricted local access point 46 uses the frequency f₂ and may also vary the output power in the same way as the first restricted local access point 26. This thus influences the interference for the first restricted local access point 26 so that the output power eventually rises above the threshold. The control unit 62 therefore decides that the best frequency is not the one used and selects another frequency, step 86. In the present example it may for instance select the third frequency f₃ instead. Thereafter the control unit 62 orders the radio communication unit 60 to vary the output power for obtaining the desired ratio, step 74, and broadcasts on this new frequency.

The method outlined above has the following advantage. It offers the best service quality for users of a restricted local access point while at the same time limiting a total system interference in a flexible way. There is furthermore ensured that repeated output power changes made by two or more restricted local access points are discontinued so that the system interference is limited. The invention thus maintains service quality, while avoiding unnecessary interference on surrounding access points.

There are a number of ways that the first restricted access point can determine if the main cause of the disturbance is another restricted local access point. One way will now be described with reference being made to FIG. 5, which shows a table indicating different numbering intervals that are used for CI (cell identities) that are identifiers of ordinary access points and restricted local access points according to one variation of the present invention. An analysis of if another access point is a restricted local access point may be performed through analysing an identity associated with the other access point and then at least a part of the CGI (Cell Global Identity) of the other access points. A CGI consists of a number of different sections, MCC (Mobile Country Code)—MNC (Mobile Network Code)—LAC (Location Area Code)—CI. CI can here for instance range between 1 and 65,535. According to this variation of the present invention, the CIs of the restricted local access points are provided in a part of this interval, which may be in the interval between 40,000 and 65,535. This means that once the first restricted local access point has identified the CGI of a certain frequency; it may directly determine that it is a restricted local access point by investigating the interval that the CI is provided in. Also the other parts of the CGI can be used in the same way. Identifying a restricted local access point may thus also be based on location area LAC or network identity, which is given by MCC plus MNC.

As mentioned above a CI is also included as a part of CGI (Cell Global Identity), which is a unique global identifier for an access point broadcast on a BCCH broadcasting channel. For an access point having a certain CGI, both these are broadcast by neighbouring access points together with BSIC identity and information of broadcasting frequency. This means that the first restricted local access point 26 may find out that for instance the third restricted local access point 46 actually is another restricted local access point by tuning in to the BCCH broadcasting channel of the first unrestricted global access point, which transmits data in the form of CGIs BSICs and information of broadcasting frequencies of neighbouring cells 18 and comparing the BSIC and broadcasting frequency of the third restricted local access point 46 with the data transmitted by the first unretricted global access point.

It is furthermore possible to directly use the BSIC which is broadcast by the third restricted local access point in the SCH (Synchronisation Channel) broadcasting channel. The BSIC includes two different codes NCC (Network Colour Code), which is a code that is normally handed out by telecommunication authorities, and BCC (Base Station Colour Code). According to the present invention one or more values of one of these codes may be pre-set to indicate that an access point is a restricted local access point. Thus the first restricted local access point may find out that a neighbouring access point is a restricted local access point by looking at either the NCC or BCC. It is also possible to investigate the training sequence code broadcast by access points, where the same NCC and BCC codes may be found. Yet another alternative is to use different broadcasting frequencies for unrestricted global access points and restricted local access points. In this case the frequency thus directly indicates the presence of a restricted local access point. It is furthermore possible that all restricted local access points adds a restricted local access point indication field in a System information message sent on a broadcasting channel. Thus the first restricted local access point may also detect this broadcast information and make a setting that the frequency is used by another restricted local access point in the access point identity store. As another alternative it is also possible that the first restricted local access point queries a network entity, such as the second traffic control unit in FIG. 1, about if a CGI or CI is associated with a restricted local access point, which traffic control unit responds with a yes or no. Common to all this is that the control unit analyses information broadcast by access points in order to determine if the main disturbing access point is caused by a restricted local access point.

The method outlined above may furthermore also be applied on the training sequence code broadcast by an access point, so that it is changed if an interfering access point uses the same training sequence.

According to the present invention, the restricted local access point may primarily select frequencies used by ordinary unrestricted global access points or primarily frequencies used by other restricted local access points.

The control unit according to the present invention can be implemented through one or more processors together with memory units comprising computer program code for performing its function. It should furthermore be realised that the radio communication unit and control unit may be combined into one and the same unit. The program code mentioned above may also be provided as a computer program product, for instance in the form of a data carrier, such as a CD ROM disc or as program code downloadable from a server.

There are several variations that are possible to make of the present invention. The disturbance is not limited to interference. It can also be other types like for instance thermal noise. The threshold was furthermore set in relation to the output power. It should also be realised that it can be set in relation to the disturbance instead. Disturbance can furthermore be measured in many ways, where a low measured value may indicate either a high or a low disturbance. This means that the relation between output power and disturbance need not be provided as a ratio. It can for instance also be provided as a product. The threshold does therefore not have to be exceeded but may be passed from any direction depending on how the disturbance is measured.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the present invention is only to be limited by the following claims.

1. A method implemented by a restricted local access point for determining output power for communication with mobile stations in a wireless network, the method comprising:
scanning, by the restricted local access point, the wireless network for determining broadcasting channels used by surrounding wireless access points, wherein the restricted local access point comprises a radio circuit in a form of a mobile station chipset which scans the wireless network for determining broadcasting channels used by surrounding wireless access points;
selecting, by the restricted local access point, a broadcasting channel that receives a lowest disturbance from surrounding access points, wherein the radio circuit is ordered to broadcast on the selected broadcasting channel;
varying, by the restricted local access point, the output power of the selected broadcasting channel in order to provide a desired relation to the lowest disturbance,
determining, by the restricted local access point, whether a main disturbing access point is another restricted local access point or an unrestricted global access point, and in case the main disturbing access point is another restricted local access point then further performing by the first restricted local access point:
setting a threshold for one of a plurality of quantities of the desired relation, which the quantity in question is not allowed to pass,
varying the output power for providing the desired relation without said quantity passing said threshold, and
selecting another channel if the desired relation cannot be obtained without the quantity passing the threshold; and
wherein the restricted local access point is one of following:
a Global System for Mobile Communications (GSM) restricted local access point; or
a General Radio Packet Service (GPRS) restricted local access point.

2. The method according to claim 1, further comprising registering identities of the surrounding access points.

3. The method according to claim 1 further comprising varying the output power for providing the desired relation in case a main disturbing access point is not another restricted local access point.

4. The method according to claim 1, wherein determining if the main disturbing access point is another restricted local access point comprises analysing information broadcast by a neigbouring access point.

5. The method according to claim 4, wherein determining if the main disturbing access point is another restricted local access point comprises analysing an identity associated with the main disturbing access point being provided in said broadcast information.

6. The method according to claim 5, wherein the identity is broadcast by another access point than the main disturbing access point.

7. The method according to claim 5, wherein the identity is broadcast by the main disturbing access point.

8. The method according to claim 4, wherein determining if the main disturbing access point is another restricted local access point comprises identifying a restricted local access point indication in a system information message broadcast by the main disturbing access point in said broadcast information.

9. The method according to any claim 1, wherein determining if a main disturbing access point is another restricted local access point comprises querying a network control unit whether said main disturbing access point is another restricted local access point and receiving an answer from said network control unit.

10. The method according to claim 1, further comprising broadcasting information that allows said first restricted local access point to be identified as a restricted local access point.

11. The method according to claim 1, wherein the broadcasting channel is primarily selected from channels used by unrestricted global access points in the network.

12. The method according to claim 1, wherein the broadcasting channel is primarily selected from channels used by other restricted local access points in the network.

13. The method according to claim 1, further comprising varying a training sequence broadcast on the selected channel based on the determined disturbances.

14. The method of claim 1, further comprising:
wherein each unrestricted global access point allows all mobile stations in the network to essentially communicate on equal terms; and
wherein each restricted global access point has a separate set of rules relating to a limited set of mobile stations within the network which allow the limited set of mobile stations to communicate with the specific restricted global access point.

15. The method of claim 1, further comprising:
wherein each unrestricted global access point allows all mobile stations in the network to essentially communicate on equal terms; and
wherein each restricted global access point has a relatively lower output power which creates a restricted range of coverage when compared to the unrestricted global access points.

16. A restricted local access point for provision in a wireless network, the restricted local access point comprising:
an antenna;
a radio circuit, connected to the antenna, wherein the radio circuit is in a form of a mobile station chipset;
a control unit comprising a processor and a memory unit that stores computer program code where the processor interfaces with the memory unit and executes the computer program code to:
order the radio circuit to scan the wireless network for determining broadcasting channels used by surrounding wireless access points in the wireless network,
select a broadcasting channel that receives the lowest disturbance by surrounding access points,
order the radio circuit to broadcast on the selected broadcasting channel;
vary the output power of the selected broadcasting channel in order to provide a desired relation to a lowest disturbance,
determine whether a main disturbing access point is another restricted local access point or an unrestricted global access point, and in case the main disturbing access point is another restricted local access point then:
set a threshold for one of a plurality of quantities of the desired relation, which the quantity in question is not allowed to pass,
vary the output power for providing the desired relation without said quantity passing said threshold,
select another channel if the desired relation cannot be obtained without the quantity passing the threshold, and
order the radio circuit to broadcast on the another channel;
wherein the restricted local access point is one of following:
a Global System for Mobile Communications (GSM) restricted local access point; or
a General Radio Packet Service (GPRS) restricted local access point.

17. The restricted local access point of claim 16, further comprising:
wherein each unrestricted global access point allows all mobile stations in the network to essentially communicate on equal terms; and
wherein each restricted global access point has a separate set of rules relating to a limited set of mobile stations within the network which allow the limited set of mobile stations to communicate with the specific restricted global access point.

18. The restricted local access point of claim 16, further comprising:
wherein each unrestricted global access point allows all mobile stations in the network to essentially communicate on equal terms; and
wherein each restricted global access point has a relatively lower output power which creates a restricted range of coverage when compared to the unrestricted global access points.

19. A restricted local access point for provision in a wireless network, the restricted local access point comprising:
an antenna;
a radio circuit, connected to the antenna, wherein the radio circuit is in a form of a mobile station chipset;
a signal conversion unit, connected to the radio circuit, wherein the signal conversion unit makes calls to mobile stations in which an initial protocol is tunneled over an unlicensed band,
a control unit comprising a processor and a memory unit that stores computer program code where the processor interfaces with the memory unit and executes the computer program code to:
order the radio circuit to scan the wireless network for determining broadcasting channels on multiple frequencies used by surrounding wireless access points in the wireless network,
select a broadcasting channel that receives the lowest disturbance by surrounding access points,
order the radio circuit to broadcast on the selected broadcasting channel utilizing one of the multiple frequencies used by the surrounding wireless access points;
vary the output power of the selected broadcasting channel in order to provide a desired relation to a lowest disturbance,
determine whether a main disturbing access point is another restricted local access point or an unrestricted global access point, and in case the main disturbing access point is another restricted local access point then:
set a threshold for one of a plurality of quantities of the desired relation, which the quantity in question is not allowed to pass,
vary the output power for providing the desired relation without said quantity passing said threshold,
select another channel if the desired relation cannot be obtained without the quantity passing the threshold, and
order the radio circuit to broadcast on the another channel;
wherein the restricted local access point and the surrounding wireless access points comprising at least one unrestricted global access point are configured to operate per the initial protocol.

20. The restricted local access point of claim 19, further comprising:
wherein each unrestricted global access point allows all mobile stations in the network to essentially communicate on equal terms; and
wherein each restricted global access point has a separate set of rules relating to a limited set of mobile stations within the network which allow the limited set of mobile stations to communicate with the specific restricted global access point.

21. The restricted local access point of claim 19, further comprising:
wherein each unrestricted global access point allows all mobile stations in the network to essentially communicate on equal terms; and
wherein each restricted global access point has a relatively lower output power which creates a restricted range of coverage when compared to the unrestricted global access points.
